(19) United States
(12) Patent Application Publication
(10) Pub. No.: US 2024/0036218 A1
(43) Pub. Date: Feb. 1, 2024

(54) FRONT-END ELECTRONIC CIRCUITRY FOR A PHOTON COUNTING APPLICATION

(71) Applicant: ams International AG, JONA (CH)

(72) Inventor: Fridolin MICHEL, AU (CH)

(73) Assignee: ams International AG, JONA (CH)

(21) Appl. No.: 18/256,062

(22) PCT Filed: Nov. 24, 2021
(86) PCT No.: PCT/EP2021/082755

§ 371 Date: Jun. 6, 2023

(30) Foreign Application Priority Data
Dec. 9, 2020 (DE) 10 2020 132 809.5

(51) Int. Cl. G01T 1/17

(52) U.S. Cl. CPC G01T 1/17

(57) ABSTRACT

A front-end electronic circuitry for a photon counting application includes an input node to receive an input signal, an output node to provide an output signal, a charge sensitive amplifier, and a feedback element having a variable resistance. The charge sensitive amplifier includes an amplifier circuit having an input side being coupled to the input node and an output side to provide the output signal, and a capacitor being arranged in a first feedback path between the input side and the output side of the amplifier circuit. The feedback element is arranged in a second feedback path in parallel to the capacitor. The variable resistance of the feedback element is dependent on a level of the output signal.

### CROSS-REFERENCE TO RELATED APPLICATIONS

The present application is the national stage entry of International Patent Application No. PCT/EP2021/082755, filed on Nov. 24, 2021, and published as WO 2022/122378 A1 on Jun. 16, 2022, which claims priority to German Application No. 10 2020 132 809.5, filed on Dec. 9, 2020, the disclosures of all of which are incorporated by reference herein in their entireties.

### TECHNICAL FIELD

The disclosure relates to a front-end electronic circuitry which may be used in photon counting application, such as multi-energy spectral CT (Computed Tomography). The disclosure further relates to a photon counting circuitry, and a device for medical diagnostics.

### BACKGROUND

In a conventional X-ray sensor, an indirect detection principle is used to detect a photon which passes easily through soft tissues of the body of a patient. Indirect detectors comprise a scintillator to convert X-rays to visible light which is captured by a photodetector or photodiode to provide an electrical signal in response to the X-rays impinging on the material of the scintillator.

In a photon counting system, a direct detection principle is used, which allows to detect and count single photon events in order to obtain intensity and spectral information. Whereas in a classical image or X-ray sensor system only the total input intensity is measured, in a photon counting system the photon energy can also be extracted because photons are detected individually.

FIG. 1 shows a block diagram of a photon counting circuitry 2, comprising a front-end electronic circuitry 10, a photon detector 20, and an energy discriminator 30. The photon detector 20 generates a transient current pulse Ipulse caused by a photon impinging a photosensitive area 21 of the photon detector 20. Detection of single photons is enabled by a special sensor material of the photosensitive area 21 (typically CdTe or CdZnTe for X-ray conversion), which converts photons into current pulses Ipulse. These current pulses Ipulse are received at an input node I10 of the front-end electronic circuitry 10 and are converted to voltage pulses Vpulse generated at an output node O10 of the front-end electronic circuitry 10.

The height of the output voltage peak is proportional to the photon energy, thus containing spectral information. Digitization of the spectral information (output pulse height) can be performed using the energy discriminator 30, for example a flash ADC, which comprises several comparators with different thresholds Vth1, . . . , VthN−1, VthN. The output signals of the comparators are then individually counted in order to obtain a spectral distribution.

The dynamics, i.e. pulse width, of the current pulses Ipulse generated by the photon detector 20 depends on a multitude of parameters. On the one hand, the detector voltage and temperature bias globally define the detector dynamics. On the other hand, photon incident position within one pixel in the photon detector leads to different detector pulse dynamics (local variation). If the pulse gain of the front-end electronic circuitry 10 is sensitive to the pulse width of the current pulses Ipulse of the photon detector 20, commonly referred to as ballistic deficit, a global variation in detector dynamics leads to count rate drift, whereas local variations increase the system noise floor.

There is a need to provide a front-end electronic circuitry for a photon counting application which has low sensitivity to the input pulse width, i.e. low ballistic deficit, to provide best system performance.

Furthermore, there is a desire to provide a photon counting circuitry having high performance regarding counting rates and energy resolution. Moreover, there is a desire to provide a device for medical diagnostics capable of operating at very high count rates.

### SUMMARY

A front-end electronic circuitry for a photon counting application having low sensitivity to the input pulse width, and thus low ballistic deficit, is specified in claim 1.

The front-end electronic circuitry comprises an input node to receive an input signal, an output node to provide an output signal, and a charge sensitive amplifier. The charge sensitive amplifier comprises an amplifier circuit having an input side being coupled to the input node, and an output side to provide the output signal. The charge sensitive amplifier further comprises a capacitor being arranged in a first feedback path between the input side and the output side of the amplifier circuit. The front-end electronic circuitry comprises a feedback element having a variable resistance. The feedback element is arranged in a second feedback path in parallel to the capacitor. The variable resistance of the feedback elements is dependent on a level of the output signal.

The front-end electronic circuitry shows low ballistic deficit/sensitivity to detector dynamics. Furthermore, a non-paralyzable model can be realized by the proposed design of the front-end electronic circuitry without baseline shift due to sub-threshold pulses of the input signal and reset noise. In particular, sensitivity to sub-threshold pulses of the input signal and reset noise is eliminated by the feedback element having a variable resistance, for example, being configured as a dynamically adjusted feedback resistor.

According to a possible embodiment of the front-end electronic circuitry, the feedback element is configured to provide a first resistance in the second feedback path when the level of the output signal is below a threshold value, and to provide a second resistance in the second feedback path when the level of the output signal is above the threshold value. The second resistance is higher than the first resistance.

According to a further embodiment of the front-end electronic circuitry, the feedback element is configured such that the resistance of the feedback element is changed in a non-linear way. In particular, the resistance of the feedback element is changed in a non-linear way, when the resistance of the feedback element is changed from the first resistance to the second resistance. The feedback element thus exhibits non-linear resistance in dependence on the front-end output voltage.

According to a possible embodiment of the front-end electronic circuitry, the feedback element is configured to provide a third resistance in the second feedback path, after providing the second resistance in the second feedback path. The third resistance is lower than the first and the second resistance.

According to a possible embodiment, the front-end electronic circuitry comprises a control circuit being configured to monitor the output signal and to control the variable resistance of the feedback element in dependence on a level of the output signal.

According to a possible embodiment of the front-end electronic circuitry, the front-end electronic circuitry comprises a controllable switch being arranged in parallel to the feedback element. The controllable switch may be configured to be switched in a conductive state after a delay, when the control circuit detects that the output signal exceeds the threshold value.

According to a possible embodiment of the front-end electronic circuitry, the control circuit comprises a comparator being configured to compare the output signal with the threshold value. The control circuit comprises a delay circuit being configured to switch the controllable switch from a non-conductive state into a conductive state, when the comparator detects that the output signal exceeds the threshold value.

The front-end electronic circuitry thus comprises a reset type front-end using dynamic resistance as the feedback element. Once a pulse of an input signal reaches the threshold value, for instance 6 times rms noise, the (feedback) capacitor is reset after some delay.

Instead of using a separate controllable switch/reset switch, the feedback element/dynamic resistance element can be controlled to perform reset. According to a possible embodiment of the front-end electronic circuitry, the feedback element is embodied as a transistor having a control terminal to apply a control signal for controlling the conductivity of the transistor. The control circuit is configured to provide different levels of the control signal in dependence on the level of the output signal.

According to a possible embodiment of the front-end electronic circuitry, the transistor is configured to provide the first resistance in the second feedback path, when the control circuit provides a first level of the control signal. Furthermore, the transistor is configured to provide the second resistance in the second feedback path, when the control circuit provides a second level of the control signal. The control circuit is configured to provide the difference between the first and second level of the control signal by coupling a temperature-stable voltage source to the control terminal of the transistor.

When switching the control node of the transistor/MOS resistor to a different potential, charge injection will occur so that the channel charge changes with different bias and is distributed on the feedback capacitor. The proposed embodiment of a temperature-stable voltage source that may be coupled to the control terminal of the transistor/MOS resistor enables this effect to be temperature invariant so that it could be calibrated out.

According to another possible embodiment of the front-end electronic circuitry, the feedback element is embodied as a transconductance amplifier. The transconductance amplifier has an input side to apply the output signal and a reference signal. The transconductance amplifier has an output side being coupled to the input side of the amplifier circuit. The control circuit comprises a transconductance control circuit to provide a transconductance control signal to set the transconductance of the transconductance amplifier. The transconductance control circuit is configured to generate the level of the transconductance control signal in dependence on the level of the output signal.

The transconductance amplifier is an active feedback element with an equivalent resistance of 1/gm which allows to implement resistance increase of the feedback element by a non-linear differentiable function.

According to a possible embodiment of the front-end electronic circuitry, a two-stage approach is described in the following. The charge sensitive amplifier, and the feedback element described above form the first stage.

According to a possible embodiment of the front-end electronic circuitry, the front-end electronic circuitry comprises a second charge sensitive amplifier. The second charge sensitive amplifier comprises a second amplifier circuit having an input side and an output side to provide a second output signal. The second charge sensitive amplifier comprises a second capacitor being arranged in a third feedback path between the input side and the output side of the second amplifier circuit. A resistor is arranged in a fourth feedback path in parallel to the second capacitor. Furthermore, the front-end electronic circuitry comprises a second controllable switch being arranged in parallel to the resistor. The front-end electronic circuitry comprises a coupling capacitor being arranged between the output side of the amplifier circuit and the second amplifier circuit.

The proposed configuration of the front-end electronic circuitry allows AC coupling of a second reset stage which eliminates the need for a baseline restorer circuit, and thus saves power, area and reduces complexity.

Nevertheless, the second stage comprising the second charge sensitive amplifier exhibits a continuous discharge path and thus would inherently increase overall ballistic deficit. Therefore, according to another possible embodiment of the front-end electronic circuitry, the second stage comprises the second feedback element having a variable resistance and thus employs the dynamic feedback resistor as well.

According to this embodiment of the front-end electronic circuitry, the front-end electronic circuitry comprises a second charge sensitive amplifier which comprises a second amplifier circuit and a second capacitor. The second amplifier circuit has an input side and an output side to provide a second output signal. The second capacitor is arranged in a third feedback path between the input side and the output side of the second amplifier circuit. The front-end electronic circuitry comprises a coupling capacitor being arranged between the output side of the amplifier circuit and the second amplifier circuit.

The front-end electronic circuitry comprises a second feedback element having a variable resistance. The variable resistance is controlled in dependence on a level of the second output signal. The second feedback element is arranged in a fourth feedback path in parallel to the second capacitor.

A photon counting circuitry having high performance regarding counting rates and energy resolution is specified in claim 14.

The photon counting circuitry comprises a front-end electronic circuitry, as described above, and a photon detector having a photon sensitive area. The photon detector is configured to generate a current pulse when a photon hits the photon sensitive area.

The photon counting circuitry further comprises an energy discriminator being connected to the output node of the front-end electronic circuitry. The photon detector is connected to the input node of the front-end electronic circuitry so that the current pulse generated by the photon detector is applied to the input node of the front-end electronic circuitry, when the photon hits the photosensitive area of the photon detector. The front-end electronic circuitry is configured to generate a voltage pulse at the output node of the front-end electronic circuitry, when the current pulse is applied to the input node of the front-end electronic circuitry. The energy discriminator is configured to generate a digital signal in dependence on a level of the voltage pulse.

A device for medical diagnostics using the principle of photon counting is specified in claim 15.

The device comprises the photon counting circuitry, as specified above. The device may be configured as an X-ray apparatus or a computed tomography scanner.

Additional features and advantages of the front-end electronic circuitry for a photon counting application are set forth in the detailed description that follows. It is to be understood that both the foregoing general description and the following detailed description are merely exemplary, and are intended to provide an overview or framework for understanding the nature and character of the claims.

### BRIEF DESCRIPTION OF THE DRAWINGS

The accompanying drawings are included to provide further understanding, and are incorporated in, and constitute a part of, the specification. As such, the disclosure will be more fully understood from the following detailed description, taken in conjunction with the accompanying figures in which:

FIG. 1 shows a block diagram of a photon counting circuitry;

FIG. 2A shows a first embodiment of a front-end electronic circuitry for a photon counting application of reset type comprising a feedback element with a variable resistance and a separate controllable reset switch;

FIG. 2B shows an embodiment of a front-end electronic circuitry for a photon counting application of reset type comprising a feedback element having a variable resistance to perform reset;

FIG. 3 shows operating waveforms of the front-end electronic circuitry for the photon counting application;

FIGS. 4A and 4B show waveforms of an adjustable resistance of the feedback element;

FIG. 5 shows a first embodiment of a front-end electronic circuitry for a photon counting application comprising a transistor as feedback element for resistance switching;

FIG. 6 shows a second embodiment of a front-end electronic circuitry for a photon counting application comprising a transconductance amplifier as feedback element having a variable non-linear resistance;

FIG. 7A shows a first embodiment of a front-end electronic circuitry for a photon counting application comprising AC-coupled first and second stages;

FIG. 7B shows a second embodiment of a front-end electronic circuitry for a photon counting application comprising AC-coupled first and second stages using a dynamic resistance element in the second stage; and

FIG. 8 shows a device for medical diagnostics comprising a photon counting circuitry.

### DETAILED DESCRIPTION OF THE EMBODIMENTS

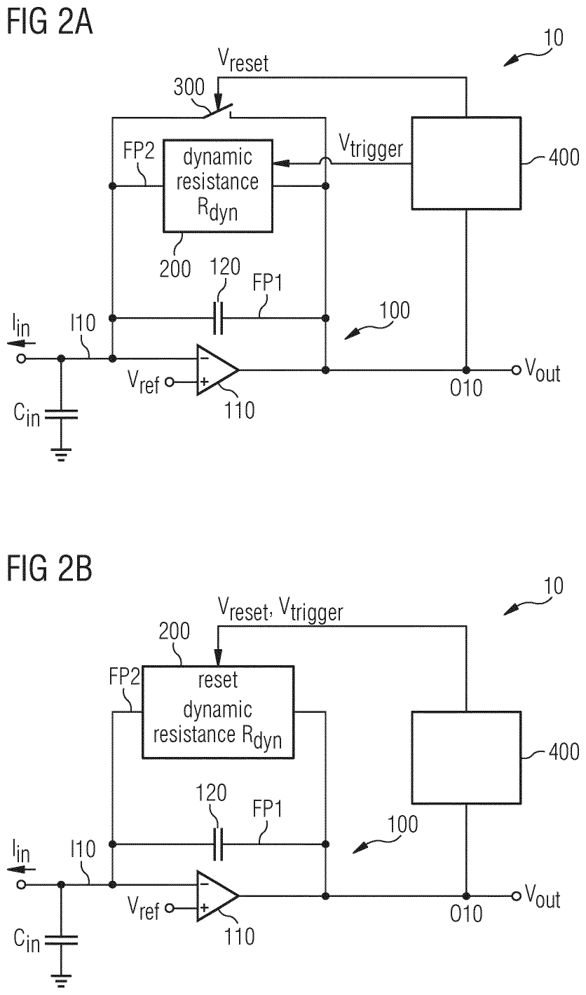

FIGS. 2A and 2B show a first and second embodiment of a front-end electronic circuitry 10 for a photon counting application of a reset type having low ballistic deficit without compromising baseline stability by sub-threshold pulses and reset noise.

The front-end electronic circuitry 10 comprises an input node I10 to receive an input Iin, and an output node O10 to provide an output signal Iout. The front-end electronic circuitry 10 comprises a charge sensitive amplifier 100. The charge sensitive amplifier 100 comprises an amplifier circuit 110 having an input side being coupled to the input node I10 and an output side to provide the output signal Vout. The output side of the amplifier circuit 110 is coupled to the output node O10. The charge sensitive amplifier 100 further comprises a capacitor 120 being arranged in a first feedback path FP1 between the input side and the output side of the amplifier circuit 110.

The front-end electronic circuitry 10 further comprises a feedback element 200 having a variable/adjustable resistance. The feedback element 200 is arranged in a second feedback path FP2 in parallel to the (feedback) capacitor 120. The variable resistance of the feedback element 200 is adjusted in dependence on a level of the output signal Vout.

Moreover, the front-end electronic circuitry 10 comprises a control circuit 400 being configured to monitor the output signal Vout and to control the variable resistance of the feedback element 200 in dependence on the level of the output signal Vout.

Referring to the embodiment of the front-end electronic circuitry 10 shown in FIG. 2A, the front-end electronic circuitry comprises a controllable switch 300 being arranged in parallel to the feedback element 200. The controllable switch 300 is configured to be switched in a conductive state after a delay, when the control circuit 400 detects that the output signal Vout exceeds a threshold value. Once a pulse of the input signal Iin reaches the minimum threshold value, for instance 6 times rms noise, the feedback capacitor 120 is reset after some delay.

Referring to the front-end electronic circuitry 10 shown in FIG. 2B, instead of using a separate controllable reset switch 300, the feedback element 200 having the variable resistance is controlled to perform reset, when the control circuit 400 detects that the output signal Vout exceeds the threshold value.

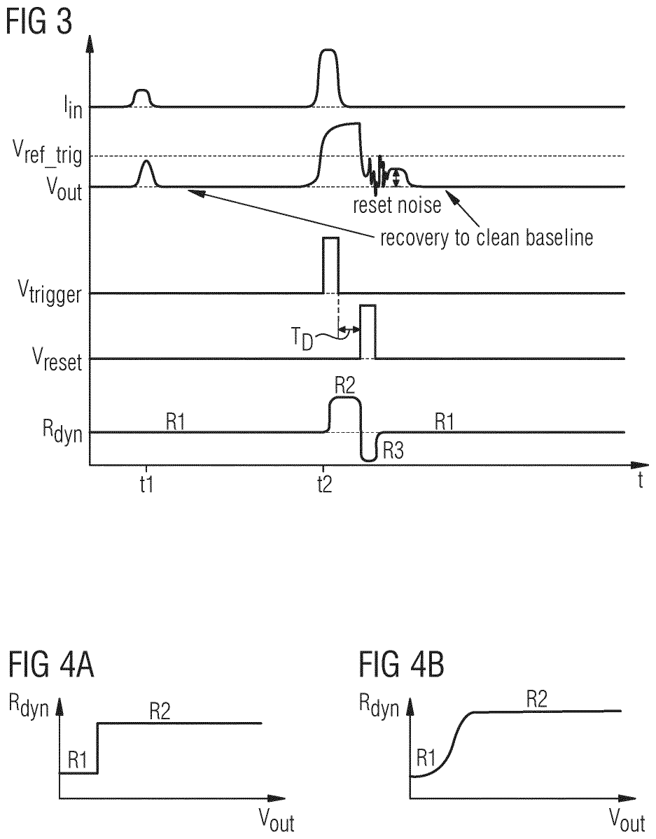

The operation of the front-end electronic circuitry 10 of FIGS. 2A and 2B is explained below using a signal flow diagram of FIG. 3 which illustrates operating waveforms of control signals of the front-end electronic circuitry 10. FIG. 3 shows, inter alia, the change of the variable resistance Rdyn of the feedback element 200 after the control circuit 400 has detected that the output signal Vout exceeds a threshold value Vref_trig. For this purpose, the feedback element 200 is configured to provide a first resistance R1 in the second feedback path FP2, when the level of the output signal Vout is below the threshold value Vref_trig. The feedback element 200 is further configured to provide a second resistance R2 in the second feedback path FP2, when the level of the output signal Vout is above the threshold value Vref_trig. As illustrated in FIG. 3, the second resistance R2 is higher than the first resistance R1.

The feedback element 200 is further configured to provide a third resistance R3 in the second feedback path FP2, after providing the second resistance R2. The third resistance R3 is lower than the first resistance R1 and the second resistance R2. The first resistance is an intermediate resistance which is below the second/high and the third/low resistance.

Referring to FIG. 3, at a first time t1, the input signal Iin shows a relatively small peak value in comparison to the peak of the input signal Iin at time t2. As further shown in FIG. 3, the level of the output signal Vout rises as a result of the small peak of the input signal Iin, but remains below the threshold value Vref_trig. As a result, the variable resistance Rdyn remains constant at the first resistance R1.

At the time t2 the front-end electronic circuitry 10 receives a high peak of the input signal Iin which causes the charge sensitive amplifier 100 to generate the output signal Vout with a rising edge which exceeds the threshold value Vref_trig. As a consequence, the control circuit 400 generates a pulse of a control signal Vtrigger, as a result of which the variable resistance of the feedback element 200 increases and reaches the second resistance R2.

Referring to the embodiment of the front-end electronic circuitry 10 of FIG. 2A, the control circuit 400 generates a pulse of a control signal Vreset after a delay time TD after output of the control signal Vtrigger. As a result the controllable switch 300 is switched in a conductive state to perform a reset of the feedback capacitor 120.

Referring to the embodiment of the front-end electronic circuitry 10 shown in FIG. 2B, the control circuit 400 also generates a pulse of the control signal Vreset after the delay time TD after output of the control signal Vtrigger. As a consequence, the variable resistance of the feedback element 200 rapidly drops to the resistance R3.

After the pulse of the control signal Vreset has decayed, the variable resistance of the feedback element 200 rises again to the original resistance R1 in both embodiments of the front-end electronic circuitry shown in FIGS. 2A and 2B.

For any levels of the input signal Iin below the threshold value Vref_trig the feedback element 200 is configured to exhibit feedback resistance of a value low enough to guarantee return to baseline within the required pulse processing time. In this way reset noise and sub-threshold pulses of the input signal Iin are removed before the next pulse arrival, i.e. there is no baseline shift.

The feedback element 200 having the variable/adjustable dynamic resistance is configured to exhibit rapidly increasing resistance, when a level of the output signal Vout, for example an output voltage, is above the detection threshold Vref_trig so that upon arrival of output signals Vout exceeding the reset threshold Vref_trig, the resistance of the feedback element 200 is increased in a non-linear fashion. As shown in FIGS. 4A and 4B, either a step-like non-linearity can be employed by switching to a higher value upon pulse detection of the output signal Vout (FIG. 4A), or the feedback element 200 is configured to increase linearity as a differentiable function (FIG. 4B).

Referring to FIG. 5, step-like linearity can be implemented by employing a transistor 210 as feedback element 200, for example, a MOS transistor biased in triode (linear) region and switching its control/gate node to a different potential upon detection of the level of the output signal Vout exceeding the threshold value Vref_trig.

Referring again to FIG. 5, the control circuit 400 comprises a comparator 410 being configured to compare the output signal Vout with the threshold value Vref_trig. When it is detected by the comparator 410 that the output signal Vout exceeds the threshold value Vref_trig, the control signal Vtrigger is generated to control controllable switch 440 of the control circuit 400. The control circuit 400 further comprises a delay circuit 420 to generate the control signal Vreset to control controllable switch 430 of the control circuit 400 after a delay, when the comparator 410 has generated the control signal Vtrigger.

The feedback element 200, which is configured as a transistor 210, has a control node to apply a control signal Vcont for controlling the conductivity of the transistor. The control circuit 400 is configured to provide different levels of the control signal Vcont in dependence on the respective switching state of the controllable switches 430 and 440, the respective switching state of the controllable switches 430 and 440 being dependent on the control signals Vreset and Vtrigger, and thus being dependent on the level of the output signal Vout.

According to the embodiment shown in FIG. 5, the transistor 210 is configured as a MOS resistor. The control circuit 400 enables the transistor/MOS resistor 210 to be controlled such that the transistor/MOS resistor 210 is operated with a first resistance R1, the second resistance R2 and the third resistance R3, as illustrated in FIG. 3.

The transistor/MOS resistor 210 is configured to provide the first resistance R1 in the second feedback path FP2 when the control circuit 400 provides a first level of the control signal Vcont. FIG. 5 shows the switching state of the controllable switches 430, 440 to generate the control signal Vcont to operate the transistor/MOS resistor 210 with the first resistance R1.

The transistor/MOS resistor 210 is further configured to provide the second resistance R2 in the second feedback path FP2 when the control circuit 400 provides a second level of the control signal Vcont. For this purpose, the switching state of controllable switch 440 changes such that the control node of the transistor 210 is coupled to a temperature stable voltage source 450 and to bias voltage source 470. The control circuit 400 is configured to provide the difference between the first and second level of the control signal Vcont by coupling the temperature stable voltage source 450 to provide a temperature stable bias offset Vb to the control terminal of the transistor/MOS resistor 210.

When switching the control node/gate of the transistor/MOS resistor 210 to a different potential, charge injection will occur, i.e. the channel charge changes with different bias and is distributed on the feedback capacitor 120. This effect can be calibrated out if it does not change with temperature. Therefore, it is important not to simply switch the control node/gate of the transistor/MOS resistor 210 to one of the supply rails, but to a temperature stable bias offset provided by the temperature stable voltage source 450 on top of the bias potential provided by bias voltage source 470, as shown in FIG. 5.

In this case, the injected charge is equal to Vb*Cgate, wherein Cgate is the gate capacitance of transistor 210, and thus the injected charge is independent of the temperature dependent bias voltage of the transistor/MOS resistor 210. Reset can be performed by tying the MOS gate to the supply rail (VDD for an NMOS transistor and VSS for a PMOS transistor), or by a separate switch in parallel.

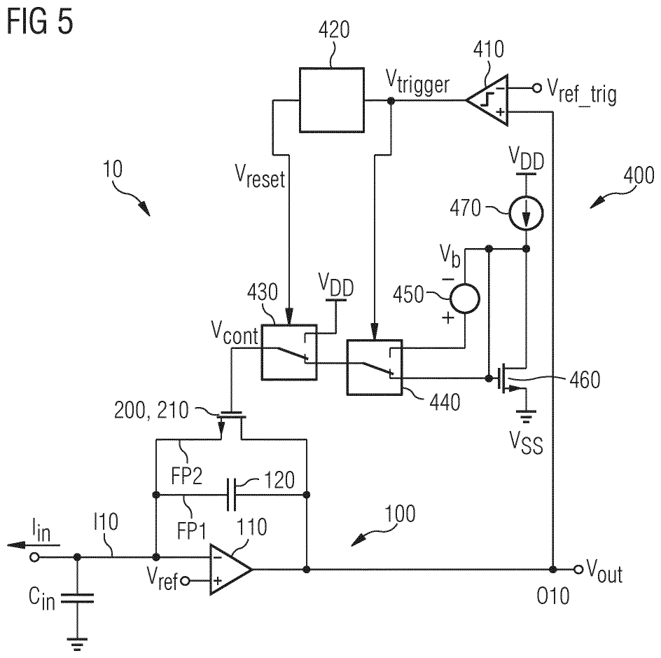

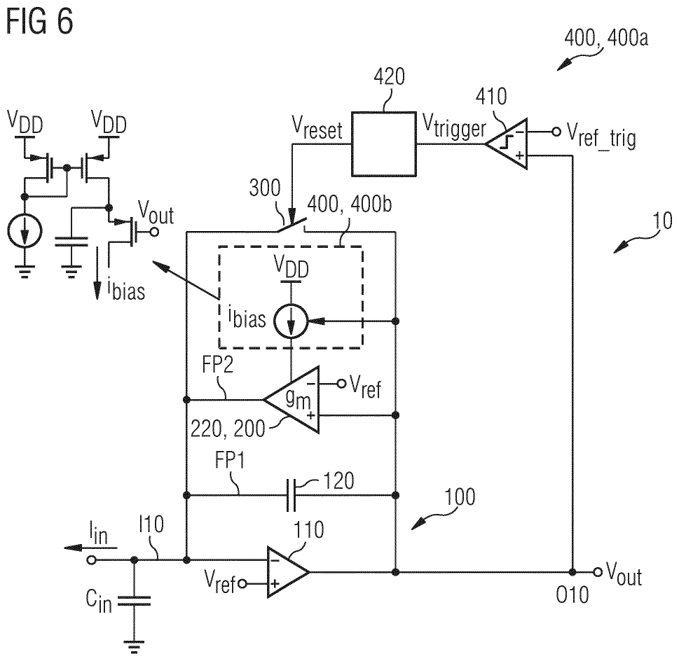

According to another possible embodiment of the front-end electronic circuitry 10, resistance increase of the feedback element 200 by a non-linear differentiable function can be implemented by using an active feedback element, i.e. a transconductor, with equivalent resistance of 1/gm. FIG. 6 shows an embodiment of the front-end electronic circuitry 10, wherein the feedback element 200 is embodied as a transconductance amplifier 220. The transconductance amplifier 220 has an input side to apply the output signal Vout and a reference signal Vref. The transconductance amplifier 220 has an output side being coupled to the input side of the amplifier circuit 110.

The control circuit 400 comprises a portion 400a and a portion 400b.

The portion 400a comprises comparator 410 to compare the output signal Vout with the threshold value Vref_trig, and delay circuit 420. The comparator 410 generates the control signal Vtrigger when the comparator 410 detects that the output signal Vout exceeds the threshold value Vref_trig. After having received the control signal Vtrigger, the delay circuit 420 generates the control signal Vreset to switch the controllable switch 300 from a non-conductive state into a conductive state to perform reset of the feedback capacitor 120.

The portion 400b of the control circuit 400 is configured as a transconductance control circuit to provide a transconductance control signal Ibias to set the transconductance of the transconductance amplifier 220. The transconductance control circuit 400b is configured to generate the level of the transconductance control signal Ibias in dependence on the level of the output signal Vout.

By adaptively biasing the transconductance amplifier 220 based on the front-end output voltage Vout, the transconductance gm can be decreased with rising level of the output voltage Vout.

A possible configuration of the transconductance control circuit 400b is also in FIG. 6 in detail. The transconductance control circuit 400b comprises a PMOS cascode transistor of the biasing branch which is turned off dynamically by output pulses of the output signal Vout. The capacitor at its source node stabilizes the source potential to introduce higher non-linearity in this bias current tuning. As there is still a transition period between low and high resistance, there will be some residual ballistic deficit. Reset for the active feedback element can be achieved by temporarily increasing the bias current so that the resistance is reduced, or by a separate switch in parallel.

As the proposed reset topology for the front-end electronic circuitry 10 presents a DC path from input to output it exhibits baseline sensitivity to detector leakage current. This is typically solved by adding a DC feedback circuit to cancel input leakage current and define the output baseline (baseline restorer circuit). However, in presence of pulse activity it is challenging to extract the baseline accurately and count rate dependent baseline shift is unavoidable. Pulse corruption of the baseline extraction can be avoided partly by sampling the baseline after some delay after reset, but in the case of two shortly spaced pulses it can still pose issues.

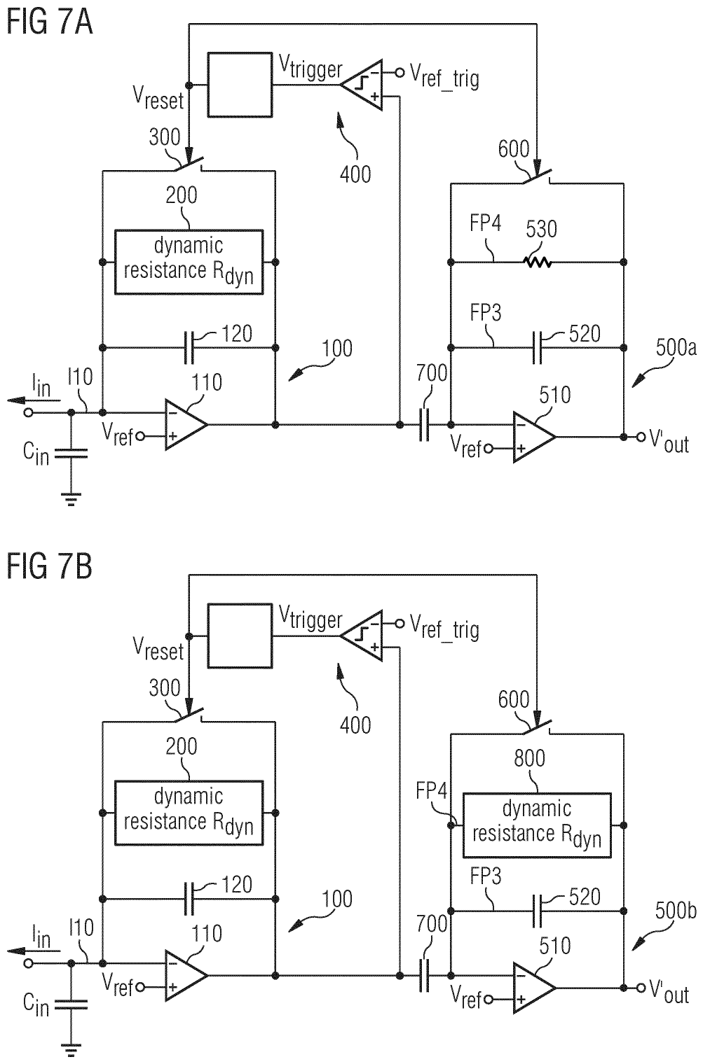

A more robust solution is AC coupling to a second stage. In order to avoid undershoot in the second stage, output pulse waveform coupling between the stages must be performed with an impedance that is matched to the first stage feedback impedance. In the proposed reset topology of the front-end electronic circuitry 10 a resistor is effectively removed upon pulse arrival so that true AC coupling can be realized. FIGS. 7A and 7B show possible embodiments of the front-end electronic circuitry 10 comprising a first and a second stage with AC coupling.

Referring to FIG. 7A, the second stage comprises a second charge sensitive amplifier 500a, a resistor 530 and a second controllable switch 600. The second charge sensitive amplifier 500a comprises a second amplifier circuit 510 having an input side and an output side to provide a second output signal Vout′. The second charge sensitive amplifier 500a comprises a second capacitor 520 being arranged in a third feedback path FP3 between the input side and the output side of the second amplifier circuit 510. The resistor 530 is arranged in a fourth feedback path FP4 in parallel to the second capacitor 520. The second controllable switch 600 is arranged in parallel to the resistor 530.

A coupling capacitor 700 is arranged between the output side of the amplifier circuit 110 of the first stage and the second amplifier circuit 510 of the second stage.

It should be noted that for sub-threshold pulses the coupling impedance is not matched because a resistive feedback path is present. However, undershoot for sub-threshold pulses is not an issue as they are small in amplitude and not processed. As shown in FIG. 7A, the second stage of the front-end electronic circuitry 10 can be realized as a conventional shaper that is reset concurrently to the first stage to avoid undershoot as a response to the first stage reset.

However, as the second stage exhibits a continuous discharge path, it inherently increases overall ballistic deficit. Therefore, for minimum ballistic deficit the second stage should employ a feedback element having a variable resistance, i.e. the dynamic feedback resistor, as well. This configuration of the front-end electronic circuitry is shown in FIG. 7B.

FIG. 7B shows an embodiment of the front-end electronic circuitry comprising a first and a second stage being coupled by the coupling capacitor 700 which is arranged between the output side of the amplifier circuit 110 of the first stage and a second amplifier circuit 510 of the second stage. Similar to the front-end electronic circuitry shown in FIG. 7A, the second stage comprises second charge sensitive amplifier 500b and second controllable switch 600. The second charge sensitive amplifier 500b includes second amplifier circuit 510 and feedback capacitor 520 being arranged in feedback path FP3 between the input side and the output side of the amplifier circuit 510.

In contrast to the second stage of the front-end electronic circuitry 10 shown in FIG. 7A, the front-end electronic circuitry 10 of FIG. 7B comprises a feedback element 800 having a variable resistance that is controlled in dependence on a level of the output signal Vout′. The feedback element 800 is arranged in a fourth feedback path FP4 in parallel to the feedback capacitor 520.

Regarding the two stage approach of the front-end electronic circuitry shown in FIG. 7B, it has to be noted that the variable resistance of the feedback element 800 could actually be controlled by both outputs of the first charge sensitive amplifier 100 and the second charge sensitive amplifier 500b because both will generate a pulse in response to an input current at the first charge sensitive amplifier.

The same applies to the controllable switch 600 of the two stage approach of the front-end electronic circuitries shown in FIGS. 7A and 7B to realize the reset functionality of the second stage. The controllable switch 600 could be triggered by the output of the first stage charge sensitive amplifier/comparator 100 after a delay or, as shown in FIGS. 7A and 7B, a second charge sensitive amplifier/comparator 500a, 500b could be employed monitoring the second stage output and trigger the controllable switch 600.

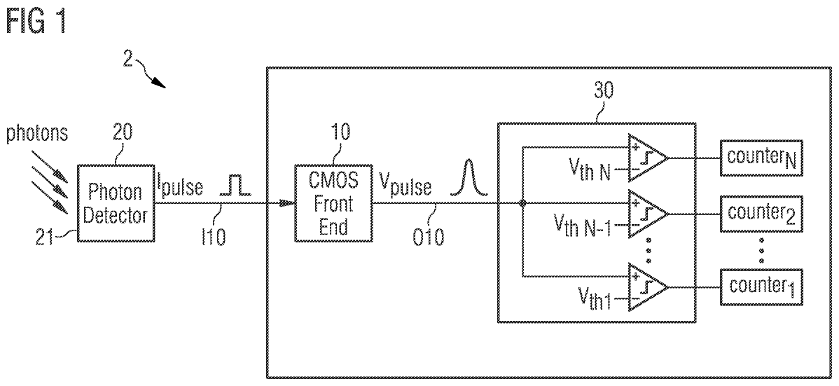

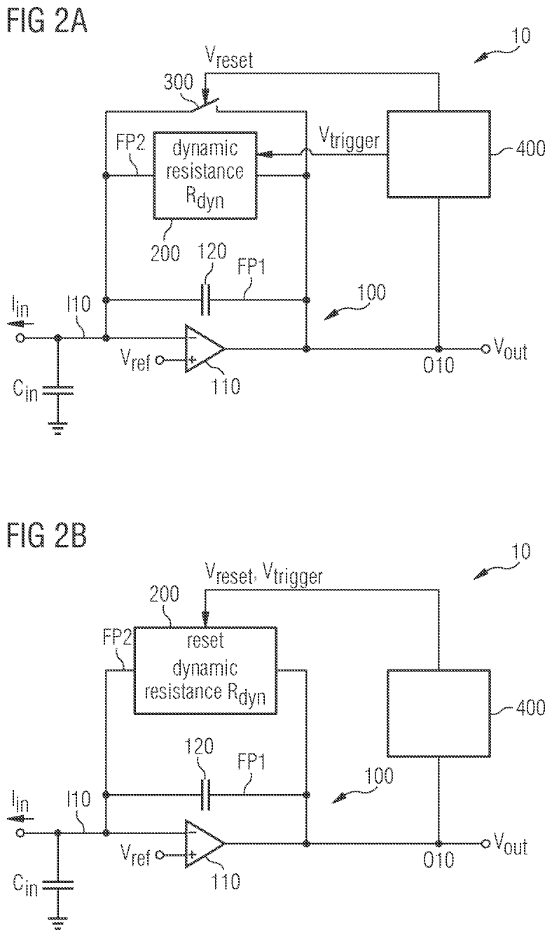

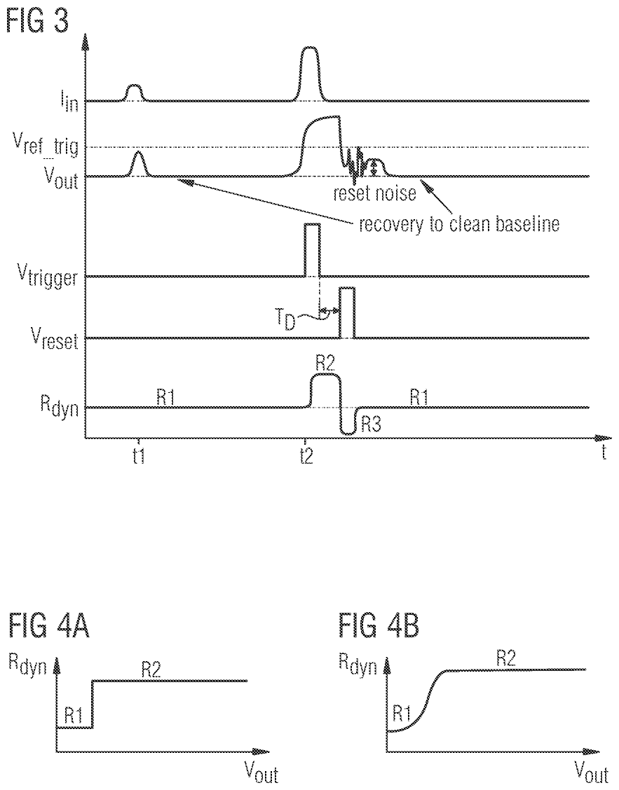

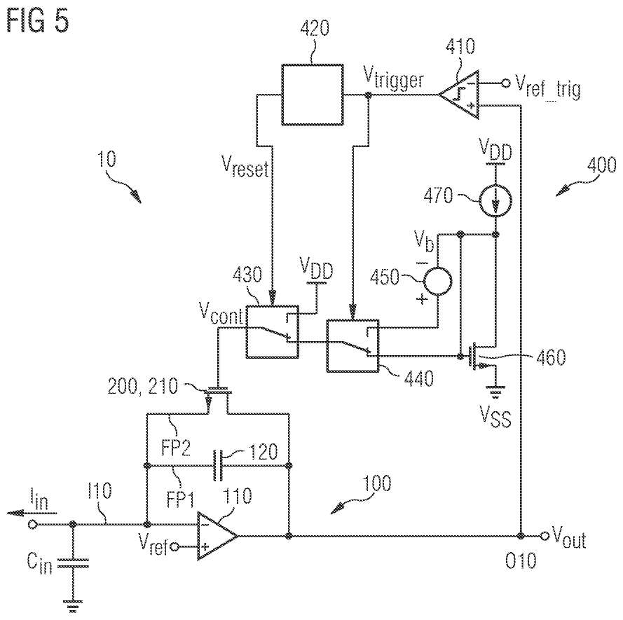

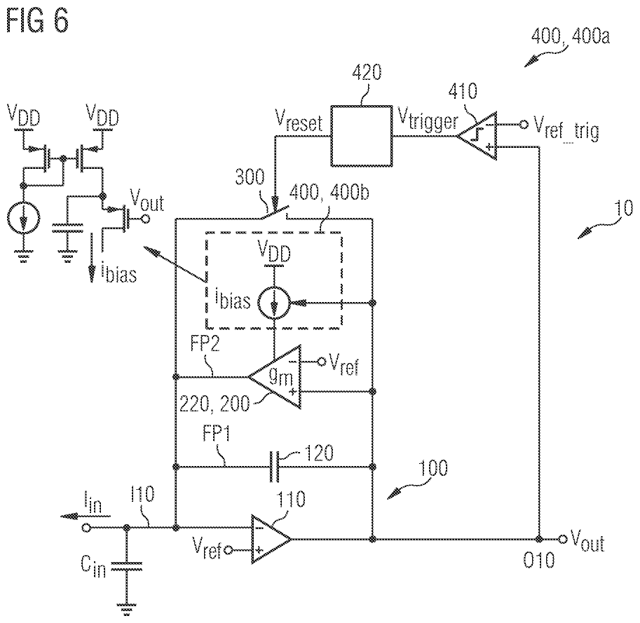

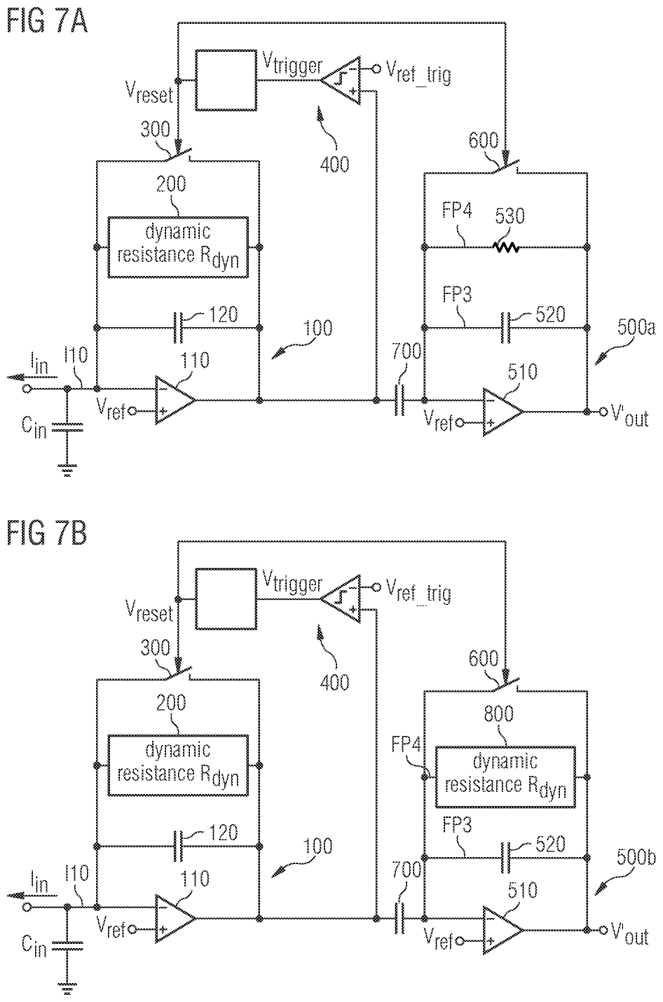

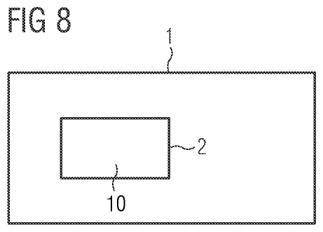

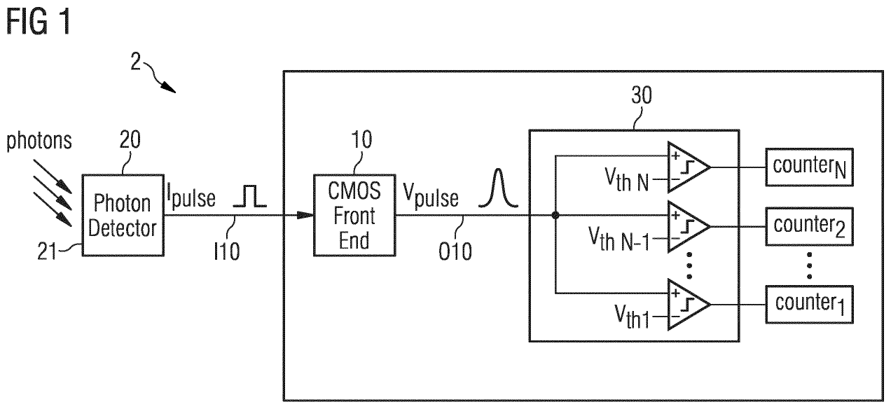

The front-end electronic circuitry 10 can be provided in a photon counting circuitry, as shown in FIG. 1. The proposed configuration of the front-end electronic circuitry 10 may be used for various photon counting applications such as computed tomography, security, baggage inspection and any other application requiring high photon counting rates and low sensitivity to input pulse width, i.e. low ballistic deficit.

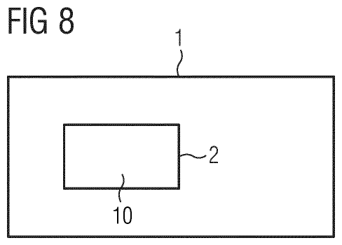

FIG. 8 shows an example of an application where a photon counting circuitry 2 equipped with a front-end electronic circuitry 10 according to one of the approaches shown in FIGS. 2A, 2B and 5 to 7B is provided in a device 1 for medical diagnostics. The device 1 for medical diagnostics may be configured, for example, as an X-ray apparatus or a computed tomography scanner.

The embodiments of the front-end electronic circuitry for a photon counting application disclosed herein have been discussed for the purpose of familiarizing the reader with novel aspects of the design of the front-end electronic circuitry for a photon counting application. Although preferred embodiments have been shown and described, many changes, modifications, equivalents and substitutions of the disclosed concepts may be made by one having skill in the art without unnecessarily departing from the scope of the claims.

In particular, the design of the front-end electronic circuitry for a photon counting application is not limited to the disclosed embodiments, and gives examples of many alternatives as possible for the features included in the embodiments discussed. However, it is intended that any modifications, equivalents and substitutions of the disclosed concepts be included within the scope of the claims which are appended hereto.

Features recited in separate dependent claims may be advantageously combined. Moreover, reference signs used in the claims are not limited to be construed as limiting the scope of the claims.

Furthermore, as used herein, the term “comprising” does not exclude other elements. In addition, as used herein, the article “a” is intended to include one or more than one component or element, and is not limited to be construed as meaning only one.

1. A front-end electronic circuitry for a photon counting application, comprising:
an input node to receive an input signal,
an output node to provide an output signal,
a charge sensitive amplifier comprising an amplifier circuit having an input side being coupled to the input node and an output side to provide the output signal, and a capacitor being arranged in a first feedback path between the input side and the output side of the amplifier circuit,
a feedback element having a variable resistance, the feedback element being arranged in a second feedback path in parallel to the capacitor, the variable resistance of the feedback element being dependent on a level of the output signal.

2. The front-end electronic circuitry of claim 1,
wherein the feedback element is configured to provide a first resistance in the second feedback path, when the level of the output signal is below a threshold value, and to provide a second resistance in the second feedback path, when the level of the output signal is above the threshold value, the second resistance being higher than the first resistance.

3. The front-end electronic circuitry of claim 1,
wherein the feedback element is configured such that the resistance of the feedback element is changed in a non-linear way.

4. The front-end electronic circuitry of claim 2,
wherein the feedback element is configured to provide a third resistance in the second feedback path, after providing the second resistance in the second feedback path, the third resistance being lower than the first and the second resistance.

5. The front-end electronic circuitry of claim 1, comprising:
a control circuit being configured to monitor the output signal and to control the variable resistance of the feedback element in dependence on a level of the output signal.

6. The front-end electronic circuitry of claim 5, comprising:
a controllable switch being arranged in parallel to the feedback element.

7. The front-end electronic circuitry of claim 6,
wherein the controllable switch is configured to be switched in a conductive state after a delay, when the control circuit detects that the output signal exceeds the threshold value.

8. The front-end electronic circuitry of claim 5,
wherein the control circuit comprises a comparator being configured to compare the output signal with the threshold value,
wherein the control circuit comprises a delay circuit being configured to switch the controllable switch from a non-conductive state in a conductive state, when the comparator detects that the output signal exceeds the threshold value.

9. The front-end electronic circuitry of claim 5,
wherein the feedback element is embodied as a transistor having a control terminal to apply a control signal for controlling the conductivity of the transistor,
wherein the control circuit is configured to provide different levels of the control signal in dependence on the level of the output signal.

10. The front-end electronic circuitry of claim 9,
wherein the transistor is configured to provide the first resistance in the second feedback path, when the control circuit provides a first level of the control signal,
wherein the transistor is configured to provide the second resistance in the second feedback path, when the control circuit provides a second level of the control signal,
wherein the control circuit is configured to provide the difference between the first and second level of the control signal by coupling a temperature stable voltage source to the control terminal of the transistor.

11. The front-end electronic circuitry of claim 1,
wherein the feedback element is embodied as a transconductance amplifier, the transconductance amplifier having an input side to apply the output signal and a reference signal, and having an output side being coupled to the input side of the amplifier circuit,
wherein the control circuit comprises a transconductance control circuit to provide a transconductance control signal to set the transconductance of the transconductance amplifier,
wherein the transconductance control circuit is configured to generate the level of the transconductance control signal in dependence on the level of the output signal.

12. The front-end electronic circuitry of claim 1, comprising:
a second charge sensitive amplifier comprising a second amplifier circuit having an input side and an output side to provide a second output signal, and a second capacitor being arranged in a third feedback path between the input side and the output side of the second amplifier circuit,
a resistor being arranged in a fourth feedback path in parallel to the second capacitor,
a second controllable switch being arranged in parallel to the resistor,
a coupling capacitor being arranged between the output side of the amplifier circuit and the second amplifier circuit.

13. The front-end electronic circuitry of claim 1, comprising:
a second charge sensitive amplifier comprising a second amplifier circuit having an input side and an output side to provide a second output signal, and a second capacitor being arranged in a third feedback path between the input side and the output side of the second amplifier circuit,
a coupling capacitor being arranged between the output side of the amplifier circuit and the second amplifier circuit,
a second feedback element having a variable resistance being controlled in dependence on a level of the first or second output signal, the second feedback element being arranged in a fourth feedback path in parallel to the second capacitor.

14. A photon counting circuitry, comprising:
a front-end electronic circuitry according to claim 1,
a photon detector having a photon sensitive area, the photon detector being configured to generate a current pulse, when a photon hits the photon sensitive area,
an energy discriminator being connected to the output node of the front-end electronic circuitry,
wherein the photon detector is connected to the input node of the front-end electronic circuitry so that the current pulse generated by the photon detector is applied to the input node of the front-end electronic circuitry, when the photon hits the photo sensitive area of the photon detector,
wherein the front-end electronic circuitry is configured to generate a voltage pulse at the output node of the front-end electronic circuitry, when the current pulse is applied to the input node of the front-end electronic circuitry,
wherein the energy discriminator is configured to generate a digital signal in dependence on a level of the voltage pulse.

15. A device for medical diagnostics, comprising:
the photon counting circuitry of claim 14,
wherein the device is configured as an X-ray apparatus or a computed tomography scanner.
